(19) United States
(12) Patent Application Publication
(10) Pub. No.: US 2007/0087772 A1
(43) Pub. Date: Apr. 19, 2007

(54) Method for uplink scheduling in a wireless mobile communication system

(75) Inventors: Byoung-Ha Yi, Seoul (KR); Jang-Hoon Yang, Seongnam-si (KR)

Correspondence Address: THE FARRELL LAW FIRM, 333 EARLE OVINGTON BOULEVARD., SUITE 701, UNIONDALE, NY, 11553, US

(73) Assignee: Samsung Electronics Co., Ltd., Suwon-si (KR)

(21) Appl. No.: 11/580,792

(22) Filed: Oct. 13, 2006

(30) Foreign Application Priority Data
Oct. 14, 2005 (KR) 2005-97119

(51) Int. Cl. H04B 7/00; H04Q 7/20

(52) U.S. Cl. 455/522; 455/513

(57) ABSTRACT

A method is provided for uplink scheduling for a mobile station (MS) in a base station (BS) in a wireless mobile communication system in which the MS sends channel quality information to the BS. At least two logical regions are set to control transmission power of the MS and the number of sub-channels to be allocated to the MS according to an interference level at which a signal of the MS affects an adjacent cell/sector. The BS allocates the MS to a specific logical region while considering channel quality information of the MS. When the specific logical region is mapped to a set of MSs whose interference to the adjacent cell/sector is large, the BS limits the transmission power of the MS and the number of sub-channels to be allocated to the MS to predefined reference values or less.

### PRIORITY

This application claims priority under 35 U.S.C. §119 to an application filed in the Korean Intellectual Property Office on Oct. 14, 2005 and assigned Serial No. 2005-97119, the contents of which are incorporated herein by reference.

### BACKGROUND OF THE INVENTION

1. Field of the Invention

The present invention generally relates to a wireless mobile communication system, and more particularly to a method for uplink scheduling in a wireless mobile communication system.

2. Description of the Related Art

Mobile communication systems are developing into high-speed, high-quality wireless data packet communication systems for providing data and multimedia services beyond initial voice-centric service. For example, 3^{rd} mobile communication systems are divided into an asynchronous system of the 3^{rd} Generation Partnership Project (3GPP) and a synchronous system of the 3^{rd} Generation Partnership Project 2 (3GPP2). The standardization work for high-speed, high-quality wireless data packet services in the 3^{rd} mobile communication systems is ongoing.

The standardization work is evidence of an effort for finding a solution for high-quality wireless data packet transfer services at 2 Mbps or more in the 3G mobile communication systems. On the other hand, 4^{th} generation (4G) mobile communication systems are based on providing higher-speed, higher-quality multimedia services.

In the wireless mobile communication systems, factors interfering with the high-speed, high-quality data service conventionally can, result from a channel environment. A channel for wireless communication frequently varies according to power variation of a received signal due to fading effect as well as additive white Gaussian noise (AWGN), shadowing, Doppler effect due to movement and frequent speed variation of a terminal, interference due to other user signals and multipath signals, etc.

New methods are required which can effectively overcome the above-described interference factors in order to provide high-speed, high-quality wireless data packet services. For example, one of the methods is an adaptive modulation and coding (AMC) scheme. The AMC scheme is a link adaptive technique for an efficient data transmission, it changes the transmission rate rather than transmission power according to channel environment, which is different from the conventional power control scheme. Herein, the transmission rate is determined by the modulation and coding scheme (MCS) level. A base station (BS) sets an MCS level to be applied to a mobile station (MS) by referring to channel quality information (CQI) fed back there from. In this case, the MS can acquire the CQI by measuring, for example, a carrier to interference and noise ratio (CINR) of a downlink signal.

Thus, a system using the AMC scheme applies a high-order modulation scheme and a high coding rate to an MS whose channel state is relatively good, but applies a low-order modulation scheme and a low coding rate to an MS whose channel state is relatively bad. In comparison with a conventional scheme relying on high-speed power control, the above-described AMC scheme can more reduce an interference signal and more improve the average performance of the system, thereby increasing the capability to adapt to time-variant characteristics of a channel. Conventionally, a broadband wireless access communication system supports various MCS levels using three modulation schemes of quadrature phase shift keying (QPSK), 16-ary quadrature amplitude modulation (16-QAM) and 64-ary quadrature amplitude modulation (64-QAM) and turbo codes of a coding rate ⅓ in a basic coding process.

FIG. 1 depicts the structure of a conventional wireless mobile communication system.

Referring to FIG. 1, the mobile communication system has a multi-cell structure with one or more cells. That is, the mobile communication system has a cell 100, a cell 150, a BS 110 covering the cell 100, and a BS 140 covering the cell 150. BSs 110 and 140 provide MSs 111, 113, 130, 151 and 153 with services. In the case of a broadband wireless access communication system, signal transmission and reception between the BS and the MSs use code division multiple access (CDMA), orthogonal frequency division multiplexing (OFDM) or orthogonal frequency division multiple access (OFDMA) scheme.

The conventional wireless mobile communication system employs the AMC scheme in order to obtain possible high processing performance and high data quality. However, when the AMC scheme is applied to uplink, the BS makes the MSs within a cell/sector maximize their transmission power such that signal power to be received from the MSs is maximized. Thus, all the MSs transmit data at maximal transmission power. The transmission power of the MS affects reception power of the BS to which the MS belongs and also acts as interference to other BSs. That is, as the transmission power of the MS increases according to the application of the uplink AMC scheme, the amount of interference to other cells/sectors increases. Consequently, a serving BS makes all the MSs within the cell/sector maximize their transmission power while expecting a maximal reception CINR. However, an increased amount of interference to adjacent BSs due to the maximized transmission power degrades data quality, i.e., signal quality, in terms of the overall system.

### SUMMARY OF THE INVENTION

Accordingly, the present invention has been designed to solve the above and other problems occurring in the prior art. Therefore, it is an object of the present invention to provide an uplink scheduling method that can minimize the interference signal affecting an adjacent cell/sector in a wireless mobile communication system.

It is another object of the present invention to provide an uplink scheduling method that can improve signal quality and signal throughput in a wireless mobile communication system.

In accordance with an aspect of the present invention, there is provided a method for uplink scheduling for a mobile station in a base station in a wireless mobile communication system in which the mobile station sends channel quality information to the base station. The method includes setting at least two logical regions for controlling transmission power of the mobile station and the number of sub-channels to be allocated to the mobile station based on the interference level at which the signal of the mobile station affects the adjacent cell/sector; allocating the mobile station to a specific logical region while considering channel quality information of the mobile station; and limiting the transmission power of the mobile station and the number of sub-channels to be allocated to the mobile station to predefined reference values or to a lesser value when the specific logical region is mapped to a set of mobile stations whose interference to the adjacent cell/sector is large.

In accordance with another aspect of the present invention, there is provided a method for applying an uplink adaptive modulation and coding (AMC) scheme to a base station for performing uplink scheduling for a mobile station in a wireless mobile communication system, including receiving instantaneous channel quality information and a transmission power value from the mobile station and setting a maximal reception power value; setting a first carrier to interference and noise ratio (CINR) value using the maximal reception power value; setting an average channel quality information value using the instantaneous channel quality information and previously received channel quality information; allocating the mobile station to a specific logical region of at least two logical regions set to control signal transmission power and the number of sub-channels to be allocated based on an interference level at which the signal of the mobile station affects an adjacent cell/sector while considering the average channel quality information value; setting the maximum number of sub-channels available in the specific logical region; setting total reception power of the specific logical region using a ratio between thermal noise and the sum of the amount of interference and thermal noise from a predefined different cell/sector; setting a second CINR value of the specific logical region using total maximal reception power; comparing the first CINR value with the second CINR value and selecting the minimal CINR value; and allocating a modulation and coding scheme (MCS) level and the number of sub-channels to the mobile station according to a result computed by comparing the selected minimal CINR value with a third CINR value mapped to an MCS level allocated to the mobile station.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the structure of a conventional wireless mobile communication system; and

FIGS. 2A and 2B are a flowchart illustrating a process for applying adaptive modulation and coding (AMC) to uplink scheduling by a base station in a wireless mobile communication system in accordance with the present invention.

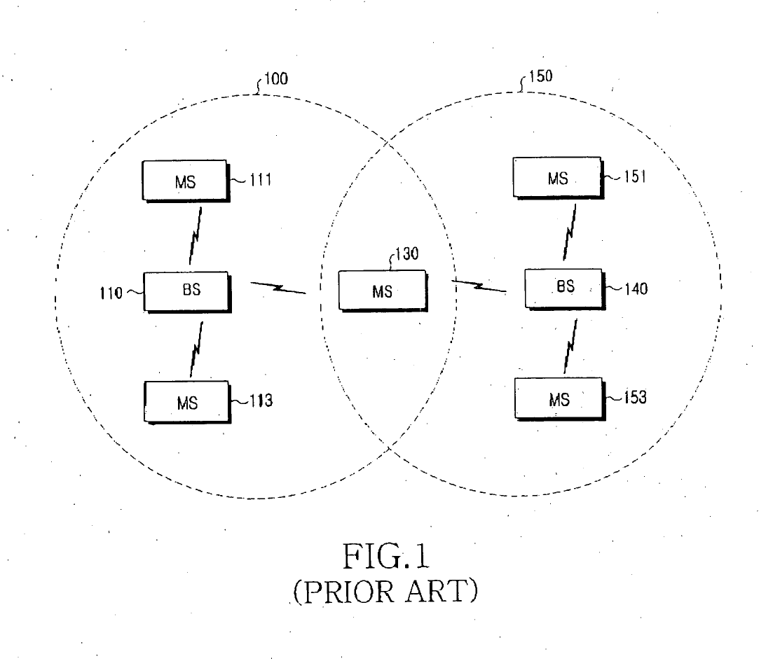

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

The present invention provides an efficient uplink scheduling method in a wireless mobile communication system. In particular, the present invention is applicable to a broadband wireless access communication system using Time Division Duplexing (TDD) scheme and a wireless broadband (WiBro) system of a mobile Internet service using the 2.3 GHz frequency band.

The TDD scheme employs the same frequency band between different downlink and uplink transmission times. A base station (BS) transmits data at maximal transmission power. Thus, a downlink interference level between the BS and a mobile station (MS) can be expressed by an uplink interference level between the BS and the MS. That is, the BS can know an interference level at which the MS interferes with other cells/sectors, using channel quality information (CQI) fed back from the MS. Herein, the CQI can be a carrier to interference and noise ratio (CINR).

For example, if the CQI fed back from the MS is good, it means that an interference signal received from other cells/sectors is weak. In other words, if the MS is at the center of a cell, it means that an amount of signal interference affecting an adjacent cell/sector is small. Further, if the CQI is bad, it means that the number of interference signals received from other cells/sectors is large. In other words, if the MS is at the edge of a cell, the amount of signal interference affecting an adjacent cell/sector is large.

Thus, the present invention provides a method for computing the amount of uplink interference, i.e., an average CQI value, by referring to CQI fed back from an MS and allocating the MS to one of logical regions divided according to the uplink interference amount. The BS adjusts maximal transmission power and the number of sub-channels to be allocated on a logical region-by-logical region basis, thereby minimizing the amount of interference affecting the adjacent cell/sector and increasing data throughput. For example, the BS limits transmission power and the number of sub-channels in a logical region including an MS causing relatively high interference to the adjacent cell/sector.

To adjust interference amounts on the logical region-by-logical region basis, the present invention employs a modified rise over thermal (ROT) (MROT) value corresponding to a ratio between thermal noise and a sum of total noise and total maximal reception power received by MSs, causing relatively high interference, from the BS. The MROT has a particular value. The conventional ROT uses a sum of all received power values within an associated cell/sector, whereas the MROT uses a sum of power from regions in which interference occurs.

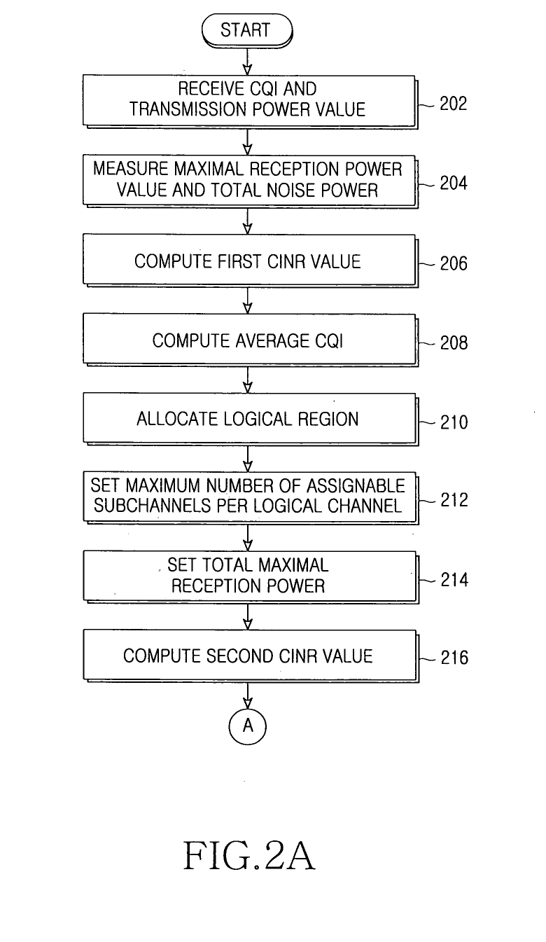

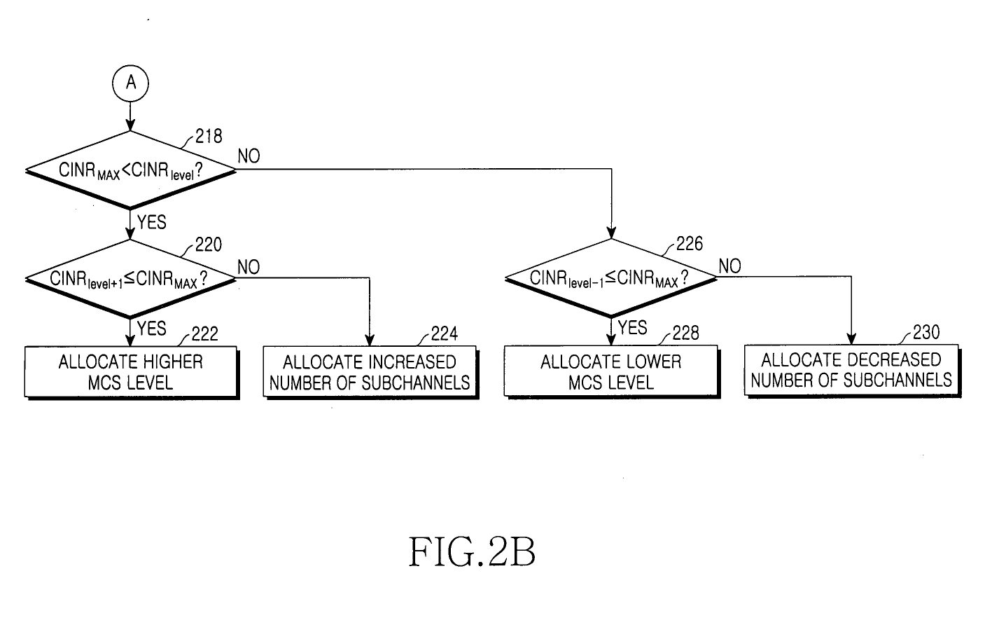

It is assumed that the number of logical regions is 3. Among three logical regions, first and second logical regions are classified into a group in which an amount of interference to an adjacent cell/sector is large. In the first and second logical regions, maximal transmission power and the number of sub-channels to be allocated to an MS are limited. A third logical region is classified into a group in which the amount of interference to an adjacent cell/sector is small, such that the appropriate modulation and coding scheme (MCS) level and the number of sub-channels are allocated to an MS. Of course, at least two logical regions can be set. A process for applying an adaptive modulation and coding (AMC) scheme for uplink scheduling for an MS in a BS will be described with reference to FIGS. 2A and 2B.

FIGS. 2A and 2B are a flowchart illustrating a process for applying the AMC to uplink scheduling by a BS in a wireless mobile communication system in accordance with an exemplary embodiment of the present invention.

The BS receives CQI and transmission power value from an MS in step 202 and then proceeds to step 204. In step 204, the BS measures the maximal reception power value P_{RX}_{_{MAX}} using the transmission power value P_{TX} and the reception power value P_{RX} estimated from a CQI signal as shown in Equation (1). Then, the BS proceeds to step 206.
P_{RX}_{_{—}}_{MAX}=P_{TX}_{_{—}}_{MAX}+P_{RX}−P_{TX} Equation (1)

In Equation (1), P_{TX}_{_{—}}_{MAX} is a value of maximal transmission power available in the MS. In step 206, the BS computes a maximal reception CINR, i.e., a first CINR value CINR_{preMAX}, using the maximal reception power value, the number of sub-channels allocated to the MS and total noise power estimated from the CQI signal as shown in Equation (2). Then, the BS proceeds to step 208.

$${CINR}_{pre MAX} = \frac{{P}_{RX\_MAX} \cdot {N}_{sch\_MAX}}{{N}_{t} \cdot {N}_{sch}} \qquad Equation ( 2 )$$

In Equation (2), Nₜ is the total noise power, N_{sch} is the number of sub-channels allocated to the current MS and N_{sch}_{_{—}}_{MAX} is the total number of sub-channels of the system.

In step 208, the BS computes an average CQI (AVG_CQI) value by substituting instantaneous CQI values received on an MS-by-MS basis into Equation (3). Then, the BS proceeds to step 210.
AVG_CQI[k]=(1−T)CQI[k−1]+T·CQI[k] Equation (3)

In Equation (3), T is an infinite impulse response (IIR) coefficient. That is, the average CQI is computed using previous and current instantaneous CQI values.

In step 210, the BS allocates an associated MS to a first logical region when the average CQI value computed using Equation (3) is less than a predefined first threshold. When the average CQI is more than the first threshold and is less than a second threshold, the BS allocates the associated MS to a second logical region. When the average CQI is more than the second threshold, the BS allocates the associated MS to a third logical region. Then, the BS proceeds to step 212.

In step 212, the BS sets the maximum number of assignable sub-channels per logical region, N_{sch}_{_{—}}_{MAX,r}. Then, the BS proceeds to step 214. The maximum number of assignable sub-channels can be set using Equation (4).

$${N}_{sch\_MAX , r} = \frac{{W}_{r} \cdot {N}_{region , r} \cdot {N}_{sch\_MAX}}{{\sum }_{r = 1}^{3} {W}_{r} \cdot {N}_{region , r}} \qquad Equation ( 4 )$$

In Equation (4), Wᵣ is a weight for setting the number of sub-channels available in each logical region, N_{sch}_{_{—}}_{MAX} is the maximum number of sub-channels available in the system and N_{region,r} is the number of MSs belonging to an associated logical region r.

In step 214, the BS substitutes a predefined MROT value into Equation (5) and sets the total maximum reception power P_{TOTAL}_{_{—}}_{RX}_{_{—}}_{MAX} from the MSs included in the first and second logical regions in which an amount of interference to adjacent cells/sectors is large, thereby adjusting the total amount of interference.
P_{TOT}_{_{—}}_{RX}_{_{—}}_{MAX}=(MROT·N₀−Nₜ) Equation (5)

In Equation (5), N₀, is a thermal noise estimate and Nₜ is a total noise estimate.

In step 216, the BS sets second CINR values in logical regions including MSs in which the amount of interference to adjacent cells/sectors is large using the total maximal reception power P_{TOTAL}_{_{—}}_{RX}_{_{—}}_{MAX} set in step 214. That is, the BS sets the maximum Modified CINR (MCINR) value of the MS belonging to the first logical region using Equation (6) and sets the MCINR value of an MS belonging to the second logical region using Equation (7). Then, the BS proceeds to step 218.

$$\begin{matrix}{MCINR}_{region 1} = \frac{Q \cdot {P}_{TOTAL\_RX \_MAX} \cdot {N}_{sch\_MAX}}{{N}_{region , 1} \cdot {N}_{t} \cdot {N}_{sch}} & Equation ( 6 ) \\ {MCINR}_{region 2} = \frac{( 1 - Q ) \cdot {P}_{TOTAL\_RX \_MAX} \cdot {N}_{sch\_MAX}}{{N}_{region , 2} \cdot {N}_{t} \cdot {N}_{sch}} & Equation ( 7 )\end{matrix}$$

In Equations (6) and (7), Q is a weight for adjusting maximal power ratios of the first and second logical regions, and N_{sch} is the number of sub-channels allocated to an associated MS.

In Equation (8), the BS compares the first CINR value computed in Equation (2) with the second CINR value computed in Equations (6) and (7). Lower values are set to maximum reception CINR values CINR_{MAX} of the first and second logical regions. In the third logical region, the first CINR value computed in Equation (2) is set to CINR_{MAX}. Equation (8) determines CINR_{MAX}.
CINR_{MAX}=min(CINR_{preMAX},MCINR_{region,r}) in region 1,2
CINR_{MAX}=CINR_{preMAX} in region 3 Equation (8)

In step 218, the BS compares the maximum reception CINR value set in Equation (8) with a CINR threshold CINRₗₑᵥₑₗ of the MCS level currently set in the MS for transmitting data according to a scheduling algorithm. If the CINR threshold of the MCS level is more than the maximum reception CINR value as a comparison result, the BS proceeds to step 226. Otherwise, the BS proceeds to step 220.

In step 220, the BS compares the maximal reception CINR value with a CINR threshold CINRₗₑᵥₑₗ₊₁ of an MCS level that is one step higher than the current MCS level. If CINRₗₑᵥₑₗ₊₁ is less than or equal to CINR_{MAX}, the BS proceeds to step 222. If CINRₗₑᵥₑₗ₊₁ is more than CINR_{MAX}, the BS proceeds to step 224. In step 222, the BS sets the MCS level of the MS to an MCS level that is one step higher than the currently allocated MCS level. In step 224, the BS allocates sub-channels whose number is more than the number of sub-channels currently allocated to the MS. In this case, the number of sub-channels allocated to the MS must not exceed the maximal number of sub-channels capable of being allocated to each logical region.

In step 226, the BS compares the maximal reception CINR value with a CINR threshold CINRₗₑᵥₑₗ₋₁ of an MCS level that is one step lower than the current MCS level. If CINRₗₑᵥₑₗ₋₁ is less than or equal to CINR_{MAX}, the BS proceeds to step 228. If CINRₗₑᵥₑₗ₋₁ is more than CINR_{MAX}, the BS proceeds to step 230. In step 228, the BS sets the MCS level of the MS to an MCS level that is one step lower than the currently allocated MCS level. In step 230, the BS allocates sub-channels whose number is less than the number of sub-channels currently allocated to the MS.

As described above, an MS included in a logical region in which an amount of interference to an adjacent cell/sector is large is assigned an MCS level mapped to the maximal reception CINR value CINR_{MAX} set by comparing an MCINR value with a CINR_{preMAX} value in accordance with the present invention, thereby minimizing interference to the adjacent cell/sector.

As is apparent from the above description, the present invention allocates a logical region for an MS causing great interference to an adjacent cell/sector and limits maximum transmission power on a logical region-by-logical region basis in a wireless mobile communication system, thereby improving total system throughput and increasing signal quality.

Although the preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is further defined by the following claims, along with their full scope of equivalents.

What is claimed is:

1. A method for uplink scheduling of a base station in a wireless mobile communication system in which a first mobile station sends channel quality information to the base station, comprising the steps of:
detecting a level of interference affecting a signal of a second mobile station located in an adjacent cell/sector;
setting at least two logical regions for controlling transmission power of the first mobile station and the number of sub-channels to be allocated to the first mobile station;
determining the first mobile station to a specific logical region while considering the channel quality information of the first mobile station; and
limiting the transmission power of the first mobile station and the number of sub-channels to be allocated to the first mobile station.

2. The method of claim 1, wherein the detecting step further comprises evaluating the level of interference on a basis of channel quality information received from the first mobile station.

3. The method of claim 1, wherein the predefined reference values are a modulation and coding scheme (MCS) level and the number of sub-channels currently allocated to the first mobile station.

4. The method of claim 1, wherein the maximum number of assignable sub-channels per logical region is predefined.

5. The method of claim 1, wherein when the channel quality information of the first mobile station is good, the first mobile station is determined to a logical region mapped to a set of mobile stations in which the number of interference signals to the adjacent cell/sector is small.

6. The method of claim 1, wherein when the channel quality information of the first mobile station is poor, the first mobile station is determined to a logical region mapped to a set of mobile stations in which the number of interference signals to the adjacent cell/sector is large.

7. A method for applying an uplink adaptive modulation and coding (AMC) scheme to a base station for performing uplink scheduling for a mobile station in a wireless mobile communication system, comprising the steps of:
receiving instantaneous channel quality information and a transmission power value from the mobile station and setting a maximum reception power value;
determining a first carrier to interference and noise ratio (CINR) value using the maximum reception power value;
determining an average channel quality information value using the instantaneous channel quality information and previously received channel quality information;
determining the mobile station to a specific logical region of at least two logical regions set to control signal transmission power and the number of sub-channels to be allocated according to an interference level at which a signal of the mobile station affects an adjacent cell/sector while considering the average channel quality information value;
determining the maximum number of sub-channels available in the specific logical region;
determining total reception power of the specific logical region using a ratio between thermal noise and a sum of an amount of interference and thermal noise from a predefined different cell/sector;
determining a second CINR value of the specific logical region using total maximal reception power;
comparing the first CINR value and the second CINR value and selecting a minimal CINR value; and
evaluating a modulation and coding scheme (MCS) level and the number of sub-channels to the mobile station according to a result computed by comparing the selected minimal CINR value with a third CINR value mapped to an MCS level allocated to the mobile station.

8. The method of claim 7, further comprising:
comparing the minimal CINR value with a fourth CINR value of an MCS level that is one step higher than a currently allocated MCS level when the minimal CINR value is greater than or equal to the third CINR value; and
allocating an MCS level that is higher than the MCS level currently allocated to the mobile station when the minimal CINR value is greater to or equal to the fourth CINR value.

9. The method of claim 8, further comprising:
allocating sub-channels whose number is more than the number of sub-channels currently allocated to the mobile station when the minimal CINR value is less than the fourth CINR value.

10. The method of claim 7, further comprising:
comparing the minimal CINR value with a fifth CINR value of an MCS level that is one step lower than a currently allocated MCS level when the minimal CINR value is less than the third CINR value; and
allocating an MCS level that is lower than the MCS level currently allocated to the mobile station when the minimal CINR value is greater than or equal to the fifth CINR value.

11. The method of claim 10, further comprising:
allocating sub-channels whose number is less than the number of sub-channels currently allocated to the mobile station when the minimal CINR value is less than the fifth CINR value.

12. The method of claim 7, wherein the maximum number of sub-channels available in the specific logical region is set by:
$${N}_{sch\_MAX , specific\_logical \_region} = \frac{{W}_{r} \cdot {N}_{specific\_logical \_region} \cdot {N}_{sch\_MAX}}{{\sum }_{r = 1}^{total\_number \_of \_logical \_regions} {W}_{r} \cdot {N}_{specific\_logical \_region}} ,$$
where N_{specific}_{_{—}}_{logical} _{_{—}}_{region} is total noise power of the specific logical region, N_{sch}_{_{—}}_{MAX} is the total number of sub-channels available in the system and Wᵣ is a weight for setting the number of sub-channels available in each logical region.

13. The method of claim 7, wherein total reception power of the specific logical region is used to adjust a total amount of interference therein and is set by:
P_{TOTAL}_{_{—}}_{RX}_{_{—}}_{MAX}=(MROT·N₀−Nₜ),
where MROT is a ratio between thermal noise and a sum of total noise and maximal reception power received by the mobile station from the base station, N₀ is thermal noise estimated in the specific logical region and Nₜ is total noise estimated in the system.

14. The method of claim 7, wherein the second CINR value of the specific logical region is set by:
$${MCINR}_{specific\_logical \_region} = \frac{Q \cdot {P}_{TOTAL\_RX \_MAX} \cdot {N}_{sch\_MAX}}{{N}_{specific\_logical \_region} \cdot {N}_{t} \cdot {N}_{sch}} ,$$
where Q is a weight for adjusting a maximal power ratio of the specific logical region, N_{sch} is the number of sub-channels allocated to an associated mobile station, N_{sch}_{_{—}}_{MAX} is the maximum number of sub-channels available in the system and Nₜ is total noise estimated in the system.

15. A method for uplink scheduling of a base station in a wireless mobile communication system in which a first mobile station sends channel quality information to the base station, comprising the steps of:
detecting a level of interference affecting a signal of a second mobile station located in an adjacent cell/sector;
setting at least two groups for controlling transmission power of the first mobile station;
determining the first mobile station to a specific group while considering the channel quality information of the first mobile station; and
limiting the transmission power of the first mobile station.

16. The method of claim 15, further comprising:
setting at least two groups for controlling the number of sub-channels to be allocated to the first mobile station.

17. The method of claim 16, further comprising:
limiting the number of sub-channels to be allocated to the first mobile station.

18. The method of claim 15, wherein the detecting step further comprises evaluating the level of interference on a basis of channel quality information received from the first mobile station.

19. The method of claim 15, wherein when the channel quality information of the first mobile station is good, the first mobile station is determined to a group mapped to a set of mobile stations in which the number of interference signals to the adjacent cell/sector is small.

20. The method of claim 15, wherein when the channel quality information of the first mobile station is poor, the first mobile station is determined to a logical region mapped to a set of mobile stations in which the number of interference signals to the adjacent cell/sector is large.
